(19) United States
(12) Patent Application Publication
(10) Pub. No.: US 2020/0203831 A1
(43) Pub. Date: Jun. 25, 2020

(54) ANTENNA DEVICE AND ELECTRONIC APPARATUS

(71) Applicant: Murata Manufacturing Co., Ltd., Nagaokakyo-shi (JP)

(72) Inventor: Keiichi ICHIKAWA, Nagaokakyo-shi (JP)

(21) Appl. No.: 16/808,427

(22) Filed: Mar. 4, 2020

Related U.S. Application Data
(63) Continuation of application No. PCT/JP2019/015424, filed on Apr. 9, 2019.

(30) Foreign Application Priority Data
May 18, 2018 (JP) 2018-096372

(51) Int. Cl. H01Q 7/06; H01Q 1/22; H01Q 1/52

(52) U.S. Cl. CPC H01Q 7/06; H01Q 1/52; H01Q 1/2225

(57) ABSTRACT

An antenna device includes first and second coil antennas. The first coil antenna includes first coil conductors defining a first coil opening, and the second coil antenna includes a second coil conductor and a third coil conductor. The second coil conductor is located in the first coil opening when viewed in the direction of an axis (in the Z-axis direction) of the first coil conductors. The third coil conductor overlaps neither the first coil conductors nor the first coil opening when viewed in the Z-axis direction. The second coil conductor and the third coil conductor are electrically connected in series, and a magnetic flux generated by the second coil conductor and a magnetic flux generated by the third coil conductor are in phase or substantially in phase.

### CROSS REFERENCE TO RELATED APPLICATIONS

This application claims the benefit of priority to Japanese Patent Application No. 2018-096372 filed on May 18, 2018 and is a Continuation Application of PCT Application No. PCT/JP2019/015424 filed on Apr. 9, 2019. The entire contents of each application are hereby incorporated herein by reference.

### BACKGROUND

### 1. Field

The description relates to an antenna device and, more specifically, to an antenna device including a plurality of coils for different systems and to an electronic apparatus including the antenna device.

### 2. Description of the Related Art

An antenna device including a coil antenna for a Near Field Communication (NFC) system and a coil antenna for a wireless power supply system is known.

For example, Japanese Unexamined Patent Application Publication No. 2016-213495 discloses an antenna device including a first coil antenna for NFC and a second coil antenna for a wireless power supply system. In the antenna device, the winding axis of the first coil antenna is parallel to the winding axis of the second coil antenna, and the second coil antenna is located in a coil opening of the first coil antenna when viewed in the winding axis direction of the first coil antenna.

When the first coil antenna and the second coil antenna are provided close to each other in the structure disclosed in Japanese Unexamined Patent Application Publication No. 2016-213495, unwanted coupling between the coil antennas may be increased, and as a result, mutual interference may occur between the coil antennas and/or between the systems. The mutual interference may be significantly reduced or prevented by increasing the distance between the coil antennas. However, such an antenna device may be large.

### SUMMARY

Preferred embodiments of the present invention provide antenna devices each including a plurality of coil antennas for a plurality of systems that are able to significantly reduce or prevent mutual interference between the coil antennas and to enable the antenna device to be more compact, and electronic apparatuses each including an antenna device.

An antenna device according to a preferred embodiment of the present invention includes a first coil antenna that is provided for a first system and includes a first coil conductor defining a first coil opening, and a second coil antenna that is provided for a second system and includes a second coil conductor defining a second coil opening and a third coil conductor defining a third coil opening. The second coil conductor is located in the first coil opening when viewed in an axial direction of the first coil conductor, the third coil conductor overlaps neither the first coil conductor nor the first coil opening when viewed in the axial direction of the first coil conductor, and the second coil conductor and the third coil conductor are electrically connected in series. A magnetic flux generated by the second coil conductor and a magnetic flux generated by the third coil conductor are in phase or substantially in phase.

An electronic apparatus according to a preferred embodiment of the present invention includes a housing and an antenna device accommodated in the housing, wherein the antenna device includes a first coil antenna that is provided for a first system and includes a first coil conductor defining a first coil opening, and a second coil antenna that is provided for a second system and includes a second coil conductor defining a second coil opening and a third coil conductor defining a third coil opening. The second coil conductor is located in the first coil opening when viewed in an axial direction of the first coil conductor, the third coil conductor overlaps neither the first coil conductor nor the first coil opening when in the axial direction of the first coil conductor, and the second coil conductor and the third coil conductor are electrically connected in series. A magnetic flux generated by the second coil conductor and a magnetic flux generated by the third coil conductor are in phase or substantially in phase.

With the above-described features, current induced to flow into the first coil conductor by the magnetic flux generated by the second coil conductor and current induced to flow into the first coil conductor by the magnetic flux generated by the third coil conductor cancel each other. This significantly reduces or prevents unwanted coupling (mutual interference) between the first coil antenna and the second coil antenna.

When one coil antenna is located in a coil opening of the other coil antenna, a large distance between the two coils is required to significantly reduce or prevent unwanted coupling between the two coils. However, the aforementioned features significantly reduce or prevent unwanted coupling between the two coil antennas, and thus, the first coil antenna and the second coil antenna may be provided adjacent to or in a vicinity of each other. This antenna device is therefore more compact than the antenna device in which the one coil antenna is located in the coil opening of the other coil antenna.

Furthermore, the magnetic flux generated by the second coil antenna extends over a wide area. An antenna device including the second coil antenna that is able to couple with coil antennas of transmission targets in a wide area is provided accordingly.

Preferred embodiments of the present invention provide antenna devices each including a plurality of coil antennas for a plurality of systems that are able to significantly reduce or prevent mutual interference between the coil antennas and to enable the antenna device to be more compact, and electronic apparatuses each including an antenna device.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a plan view of an antenna device 101 according to a first preferred embodiment of the present invention, and FIG. 1B is a sectional view of the antenna device 101 taken along line A-A in FIG. 1A.

FIG. 2A is a plan view of the antenna device 101, and FIG. 2B is a perspective plan view of the antenna device 101, showing, for example, first coil conductors 31b provided on a second surface of a substrate.

FIG. 3 is a sectional view of the antenna device 101 taken along line B-B in FIG. 2A.

FIG. 4 is a circuit diagram of an electronic apparatus 301 including the antenna device 101 according to the first preferred embodiment of the present invention.

FIG. 5A is a plan view of an antenna device 102 according to a second preferred embodiment of the present invention, and FIG. 5B is a sectional view of the antenna device 102 taken along line C-C in FIG. 5A.

FIG. 6A is a plan view of an antenna device 103 according to a third preferred embodiment of the present invention, and FIG. 6B is a sectional view of the antenna device 103 taken along line D-D in FIG. 6A.

FIG. 7A is a plan view of an antenna device 104 according to a fourth preferred embodiment of the present invention, and FIG. 7B is a sectional view of the antenna device 104 taken along line E-E in FIG. 7B.

FIG. 8A is a plan view of an electronic apparatus 302 according to a fifth preferred embodiment of the present invention, and FIG. 8B is a sectional view of the electronic apparatus 302 taken along line F-F in FIG. 8A.

### DETAILED DESCRIPTION OF THE PREFERRED EMBODIMENTS

The following describes preferred embodiments of the present invention by describing some specific examples with reference to the accompanying drawings. In the drawings, the same reference signs refer to the same or similar portions. To provide the main points or to facilitate understanding, several preferred embodiments will be described separately for convenience. It should be noted that partial replacements or combinations of features shown and described in different preferred embodiments are possible. Redundant description of features common to a first preferred embodiment and another preferred embodiment will be omitted, and a second preferred embodiment and subsequent preferred embodiments will be described with regard to only their distinctive features. Specifically, not every preferred embodiment refers to features and advantages provided by similar configurations.

Coil antennas described in the following preferred embodiments of the present invention are to be included in a wireless transmission system that performs wireless transmission with a coil antenna of an external apparatus (a communication target) through magnetic field coupling. Herein, the term “transmission” may refer to transmission and reception of signals and to transmission and reception of electric power. The term “wireless transmission system” may refer to a near field communication system and a wireless power supply system. Each coil antenna is sufficiently smaller than the wavelength A of the frequency used. In the frequency band used, radiation efficiency for electromagnetic waves is low. The size of the coil antenna is preferably less than or equal to about λ/10, for example. More specifically, a current path of the coil antenna, namely, a coil conductor, which will be described later, has a length of about λ/10 or less. The term “wavelength” herein refers to an effective wavelength determined in view of the fact that the wavelength may be reduced due to the dielectricity and/or the magnetic permeability of the substrate on which the conductor is provided. Both ends of the coil conductor included in the coil antenna are electrically connected to a power supply circuit. Current of substantially uniform intensity flows though the current path, namely, the coil conductor of the coil antenna. Antenna devices described in the following preferred embodiments are devices that actually perform wireless transmission with antenna devices of external apparatuses through magnetic field coupling by using the coil antennas described in the preferred embodiments.

Methods associated with such a wireless power supply system and applicable to the antenna devices described in the following preferred embodiments include magnetic field coupling methods, such as the electromagnetic induction method and the magnetic field resonance method. Standards for wireless power supply according to the electromagnetic induction method include, for example, the “Qi (registered trademark)” standard established by the Wireless Power Consortium (WPC). The frequency band to be used in the electromagnetic induction method is, for example, a frequency range of about 100 kHz to about 300 kHz. Standards for wireless power supply according to the magnetic field resonance method include the “AirFuel (registered trademark) Resonant” standard established by the AirFuel Alliance. The frequency band to be used in the magnetic field resonance method is, for example, the 6.78-MHz band or the 100-kHz band.

Near field wireless communication applicable to the antenna devices described in the following preferred embodiments include Near Field Communication (NFC). The frequency band to be used in the near field communication is, for example, the HF band. More specifically, the near field communication may be used in a frequency of about 13.56 MHz.

In the following preferred embodiments, the term “electronic apparatus” refers to mobile phone terminals such as smart phones and feature phones, for example; wearable terminals such as smart watches and smart glasses, for example; portable PCs such as notebook PCs and tablet PCs, for example; information apparatuses such as cameras, game consoles, and toys, for example; information media such as IC tags, SD cards, SIM cards, and IC cards, for example; and other various electronic apparatuses.

### First Preferred Embodiment

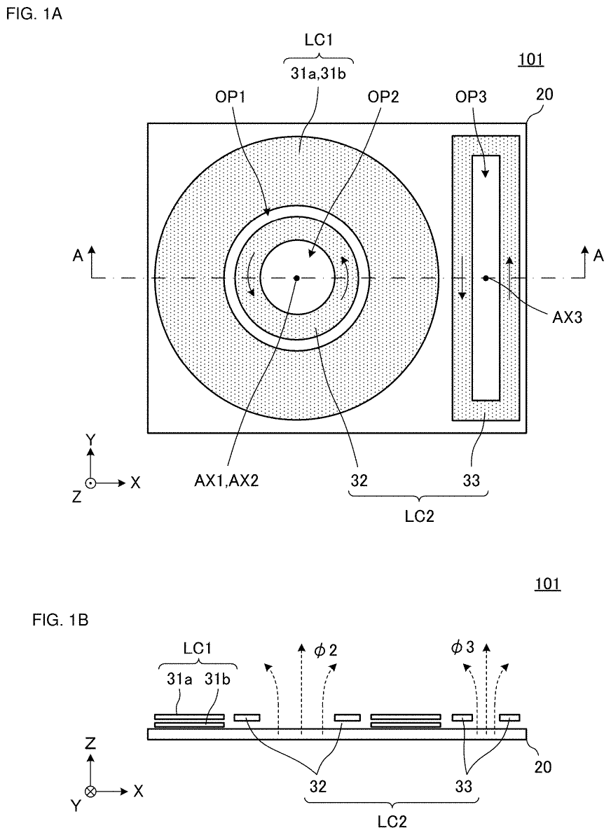

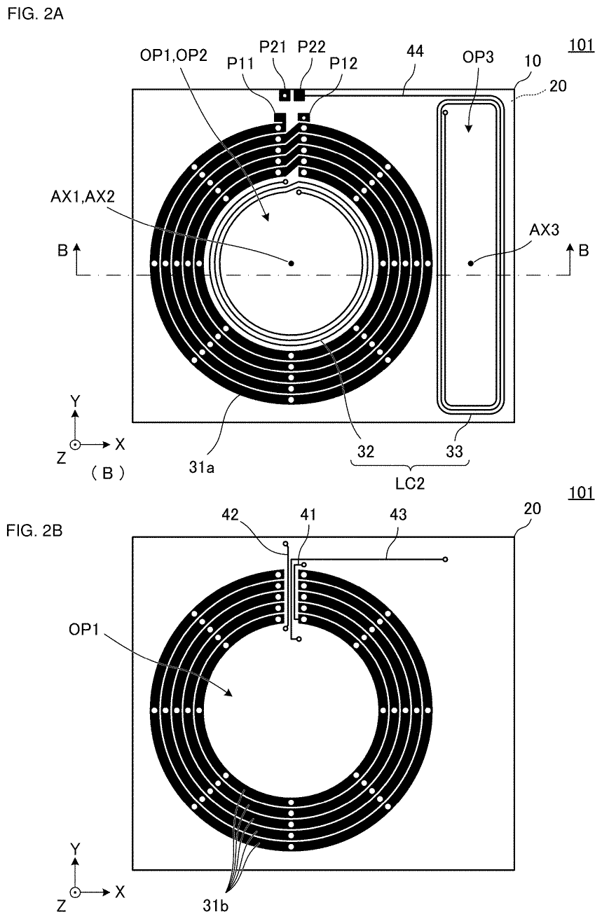

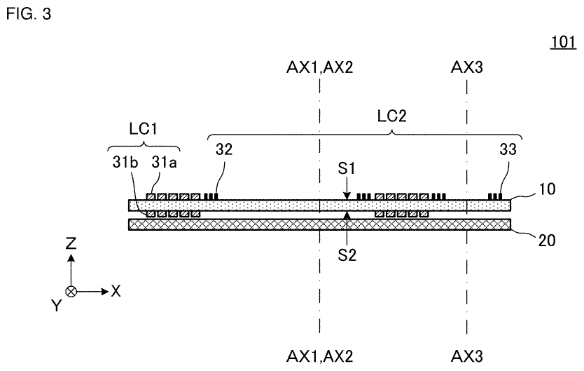

FIG. 1A is a plan view of an antenna device 101 according to a first preferred embodiment of the present invention, and FIG. 1B is a sectional view of the antenna device 101 taken along line A-A in FIG. 1A. FIG. 2A is a plan view of the antenna device 101, and FIG. 2B is a perspective plan view of the antenna device 101, showing, for example, first coil conductors 31b provided on a second surface of a substrate. FIG. 3 is a sectional view of the antenna device 101 taken along line B-B in FIG. 2A. Each of FIGS. 1A and 1B shows only the outer shape of a first coil antenna LC1 (a first coil conductor 31a and the first coil conductors 31b) and the outer shape of a second coil antenna LC2 (a second coil conductor 32 and a third coil conductor 33). For structural clarity, interlayer connection conductors shown in FIGS. 2A and 2B are indicated by open circles.

The antenna device 101 includes a substrate 10, the first coil antenna LC1 for a first system, the second coil antenna LC2 for a second system, and a magnetic material sheet 20. The first system is a wireless power supply system such as a magnetic-field resonance power transmission system, for example. The second system is a near field communication system such as NFC, for example.

The substrate 10, on which the first coil antenna LC1 and the second coil antenna LC2 are provided, may be a flexible, flat plate having a rectangular or substantially rectangular shape whose longitudinal direction coincides with the X-axis direction. The substrate 10 includes a first surface S1 and a second surface S2, which are located opposite to each other. The substrate 10 is preferably a thermoplastic resin sheet including, for example, polyimide (PI) or a liquid crystal polymer (LCP).

The first coil antenna LC1 includes the first coil conductors 31a and 31b. The first coil conductor 31a is preferably a spiral conductor pattern that is provided on the first surface S1 of the substrate 10 and includes about five turns, for example. The first coil conductors 31b are looped conductor patterns provided on the second surface S2 of the substrate 10 that overlap the first coil conductor 31a when the substrate 10 is viewed in plan. Instead of being located in the middle of the substrate 10, the first coil conductors 31a and 31b are located adjacent to or in a vicinity of a first side (the left side of the substrate 10 shown in FIG. 2A) when the first surface S1 is viewed in plan (viewed in the Z-axis direction). The first coil conductors 31a and 31b are conductor patterns preferably including, for example, Cu foil.

The first coil conductors 31a and 31b are electrically connected in parallel at a plurality of points via the interlayer connection conductors provided on the substrate 10. A first end of the first coil conductor 31a (one end of the first coil antenna LC1) is electrically connected to an outer electrode P11. These features are able to provide a reduction in the direct-current resistance of the first coil antenna LC1. A second end of the first coil conductor 31a (the other end of the first coil antenna LC1) is electrically connected to an outer electrode P12 via a conductor 41 and the interlayer connection conductors provided on the substrate 10.

As shown in FIGS. 2A and 2B, the first coil conductors 31a and 31b are wound about an axis AX1 to define a first coil opening OP1. In preferred embodiments of the present invention, the expression “a first coil conductor defines a first coil opening” means that a first coil conductor is wound about an axis to define a first coil opening surrounded by the first coil conductor.

The second coil antenna LC2 includes the second coil conductor 32 and the third coil conductor 33. The second coil conductor 32 is a spiral conductor pattern that is preferably provided on the first surface S1 of the substrate 10 and includes about three turns, for example. The third coil conductor 33 is a spiral conductor pattern that is preferably provided on the first surface S1 of the substrate 10 and includes about three turns, for example. As shown in, for example, FIG. 1A and FIG. 2A, the second coil conductor 32 is located in the first coil opening OP1 when viewed in the direction of the axis AX1 of the first coil conductors 31a and 31b (when viewed in the Z-axis direction). The third coil conductor 33 overlaps neither the first coil conductors 31a and 31b nor the first coil opening OP1 when viewed in the Z-axis direction. The third coil conductor 33 is provided adjacent to or in a vicinity of a second side of the substrate 10 (the right side of the substrate 10 shown in FIG. 2A). The second coil conductor 32 and the third coil conductor 33 are conductor patterns preferably including, for example, Cu foil.

The first coil conductors 31a and 31b according to the first preferred embodiment are provided along the first surface S1 and the second surface S2 of the substrate 10. Thus, the expression “when viewed in the direction of the axis AX1 of the first coil conductors 31a and 31b (when viewed in the Z-axis direction)” may be replaced with the expression “when the first surface S1 or the second surface S2 of the substrate 10 is viewed in plan” or “when the first coil conductors 31a and 31b are viewed in plan”.

As shown in, for example, FIG. 2A, the second coil conductor 32 is wound about an axis AX2 to define a second coil opening OP2. The third coil conductor 33 is wound about an axis AX3 to define a third coil opening OP3. In the first preferred embodiment, the axis AX2 of the second coil conductor 32 coincides with the axis AX1 of the first coil conductors 31a and 31b.

In preferred embodiments of the present invention, the expression “a second coil conductor defines a second coil opening” means that a second coil conductor is wound about an axis to define a second coil opening surrounded by the second coil conductor. In preferred embodiments of the present invention, the expression “a third coil conductor defines a third coil opening” means that a third coil conductor is wound about an axis to define a third coil opening surrounded by the third coil conductor.

A first end of the second coil conductor 32 (one end of the second coil antenna LC2) is electrically connected to an outer electrode P21 via a conductor 42 and the interlayer connection conductors provided on the substrate 10. A second end of the second coil conductor 32 is electrically connected to a first end of the third coil conductor 33 via a conductor 43 and the interlayer connection conductors provided on the substrate 10. A second end of the third coil conductor 33 (the other end of the second coil antenna LC2) is electrically connected to an outer electrode P22 via a conductor 44 provided on the substrate 10.

The second coil conductor 32 and the third coil conductor are electrically connected in series, and a magnetic flux generated by the second coil conductor 32 and a magnetic flux generated by the third coil conductor 33 are in phase or substantially in phase. The magnetic flux generated by the second coil conductor 32 and the magnetic flux generated by the third coil conductor 33 are in the same or substantially the same orientation in the Z-axis direction, that is, in the direction normal or substantially normal to the second coil opening OP2 and in the direction normal or substantially normal to the third coil opening OP3. When the current path is traced from the outer electrode P21 to the outer electrode P22, the second coil conductor 32 is wound counterclockwise about the axis AX2 and the third coil conductor 33 is wound counterclockwise about the axis AX3. In other words, when a left-handed current flows through the second coil conductor 32 when viewing the second coil conductor 32 and the third coil conductor 33 in the direction of the axis AX2 of the second coil conductor 32, a left-handed current flows through the third coil conductor 33. When the winding direction of the second coil conductor 32 and the winding direction of the third coil conductor 33 coincide with each other, a mutual inductance M23 associated with coupling between the second coil conductor 32 and the third coil conductor 33 has a negative value.

The magnetic material sheet 20 is a flat plate having a rectangular or substantially rectangular shape whose longitudinal direction coincides with the X-axis direction. As shown in, for example, FIG. 3, the planar shape of the magnetic material sheet 20 is identical or substantially identical to the planar shape of the substrate 10. The magnetic material sheet 20 faces the second surface S2 of the substrate 10. The magnetic material sheet 20 is a sheet preferably including, for example, NiZn ferrite. The material of the magnetic material sheet 20 is not limited to the above, and another material such as, for example, a sheet including MnZn ferrite or a sheet including a soft magnetic alloy may be used.

As shown in FIGS. 1A and 2A, the magnetic material sheet 20 overlaps the first coil conductors 31a and 31b, the first coil opening OP1, the second coil conductor 32, the second coil opening OP2, the third coil conductor 33, and the third coil opening OP3 when viewed in the Z-axis direction.

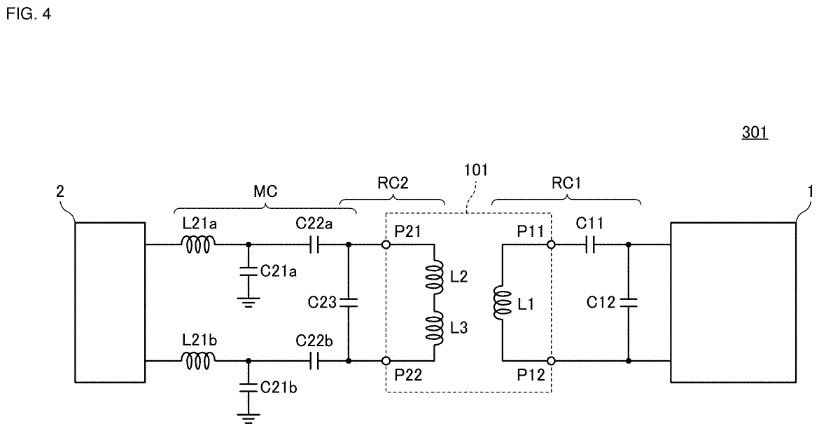

FIG. 4 is a circuit diagram of an electronic apparatus 301 including the antenna device 101 according to the first preferred embodiment. Referring to FIG. 4, the first coil conductors 31a and 31b shown in FIG. 2A are represented as an inductor L1. Similarly, the second coil conductor 32 is represented as an inductor L2, and the third coil conductor 33 is represented as an inductor L3.

The electronic apparatus 301 includes the antenna device 101, a first system circuit 1, a second system circuit 2, inductors L21a and L21b, and capacitors C11, C12, C21a, C21b, C22a, C22b, and C23. The electronic apparatus 301 also includes other components, which are not shown. The first system circuit 1 is, for example, a power transmission circuit or a power reception circuit for a wireless power supply system. The second system circuit 2 is, for example, a balanced input RFIC. The inductors L21a and L21b are, for example, chip inductors. The capacitors C11, C12, C21a, C21b, C22a, C22b, and C23 are, for example, chip capacitors.

The inductor L1 (both ends of the first coil conductor) is electrically connected to the first system circuit 1 via the capacitor C11. The capacitor C11 is electrically connected in series with and between the inductor L1 and the first system circuit 1. The capacitor C12 is electrically connected in parallel to the inductor L1.

The inductors L2 and L3 electrically connected in series (the first end of the second coil conductor and the second end of the third coil conductor) are electrically connected to the second system circuit 2 via a matching circuit MC, which will be described later. The capacitor C23 is electrically connected in parallel to the inductors L2 and L3 electrically connected in series.

As shown in FIG. 4, the first coil conductor (the inductor L1) and the capacitors C11 and C12 define a first resonant circuit RC1. Similarly, the second coil conductor (the inductor L2), the third coil conductor (the inductor L3), and the capacitor C23 define a second resonant circuit RC2.

As shown in FIG. 4, the matching circuit MC is electrically connected between the antenna device 101 and the second system circuit 2. The inductors L21a and L21b and the capacitors C21a, C21b, C22a, and C22b define the matching circuit MC. Among these components, the inductors L21a and L21b also define and function as electro-magnetic compatibility (EMC) filters.

The antenna device 101 according to the present preferred embodiment provides the following features and advantages.

The antenna device 101 according to the first preferred embodiment includes the following features. When viewed in the Z-axis direction, the second coil conductor 32 is located in the first coil opening OP1. When viewed in the Z-axis direction, the third coil conductor 33 overlaps neither the first coil conductors 31a and 31b nor the first coil opening OP1. The second coil conductor 32 and the third coil conductor 33 are electrically connected in series, and a magnetic flux generated by the second coil conductor 32 and a magnetic flux generated by the third coil conductor 33 are in phase or substantially in phase. Accordingly, current induced to flow into the first coil conductors 31a and 31b by a magnetic flux φ2 generated by the second coil conductor 32 and current induced to flow into the first coil conductors 31a and 31b by a magnetic flux φ3 generated by the third coil conductor 33 cancel each other. This significantly reduces or prevents unwanted coupling (mutual interference) between the first coil antenna LC1 and the second coil antenna LC2.

When one coil antenna is located in a coil opening of the other coil antenna, a large distance between the two coils is required to significantly reduce or prevent unwanted coupling between the two coils. However, the aforementioned features significantly reduce or prevent unwanted coupling between the two coil antennas, and thus, the first coil antenna LC1 and the second coil antenna LC2 may be provided adjacent to or in a vicinity of each other. This antenna device is therefore more compact (has a smaller footprint on an X-Y plane for the formation of the first coil antenna LC1 and the second coil antenna LC2) than the antenna device in which the one coil antenna is located in the coil opening of the other coil antenna.

The second coil antenna LC2 according to the first preferred embodiment is segmented into the second coil conductor 32 in the first coil opening OP1 and the third coil conductor 33 on the +X side of the first coil antenna LC1. Thus, the second coil antenna LC2 does not extend along the entire perimeter of the first coil antenna LC1. The area of this antenna device in the Y-axis direction may therefore be smaller than the area of an antenna in which the second coil antenna LC2 extends along the entire perimeter of the first coil antenna LC1.

The first preferred embodiment further includes the following features. When viewed in the Z-axis direction, the second coil conductor 32 is located in the first coil opening OP1. When viewed in the Z-axis direction, the third coil conductor 33 is located outside the first coil antenna LC1. The second coil conductor 32 and the third coil conductor 33 are electrically connected in series, and magnetic fluxes generated by the respective coil conductors are in phase or substantially in phase. Accordingly, a magnetic flux generated by the second coil antenna LC2 extends over a wide area. An antenna device including the second coil antenna LC2 that is able to couple with coil antennas of transmission targets in a wide area is provided accordingly. These features are also able to provide a more compact antenna device without narrowing the range in which the second coil antenna LC2 can couple with coil antennas of transmission targets.

In the antenna device 101 according to the first preferred embodiment, the magnetic material sheet 20 is provided on the magnetic path of the first coil antenna LC1 and the magnetic path of the second coil antenna LC2. Coil antennas having a predetermined inductance despite their smallness are provided accordingly. Furthermore, the magnetic material sheet 20 produces a magnetic convergence effect to strengthen the magnetic field coupling between the first coil antenna LC1 and the coil antenna of its transmission target or between the second coil antenna LC2 and the coil antenna of its transmission target.

The coupling between the first coil antenna LC1 and the second coil antenna LC2 may vary depending on, for example, the shapes of coil conductors (a first coil conductor 31, the second coil conductor 32, and the third coil conductor 33), the number of turns of each coil conductor, the positional relationship between the coil conductors, and the shapes and sizes of the coil openings (the first coil opening OP1, the second coil opening OP2, and the third coil opening OP3). That is, including the above-described changes enables control over the coupling between the first coil antenna LC1 and the second coil antenna LC2, the antenna characteristics of the first coil antenna LC1, and the antenna characteristics of the second coil antenna LC2.

### Second Preferred Embodiment

A second preferred embodiment of the present invention will be described below by describing an example including a second coil antenna that is different from the second coil antenna according to the first preferred embodiment. In the second preferred embodiment and subsequent preferred embodiments, the substrate 10 and the first coil conductor 31b provided on the second surface S2 of the substrate 10 are not shown.

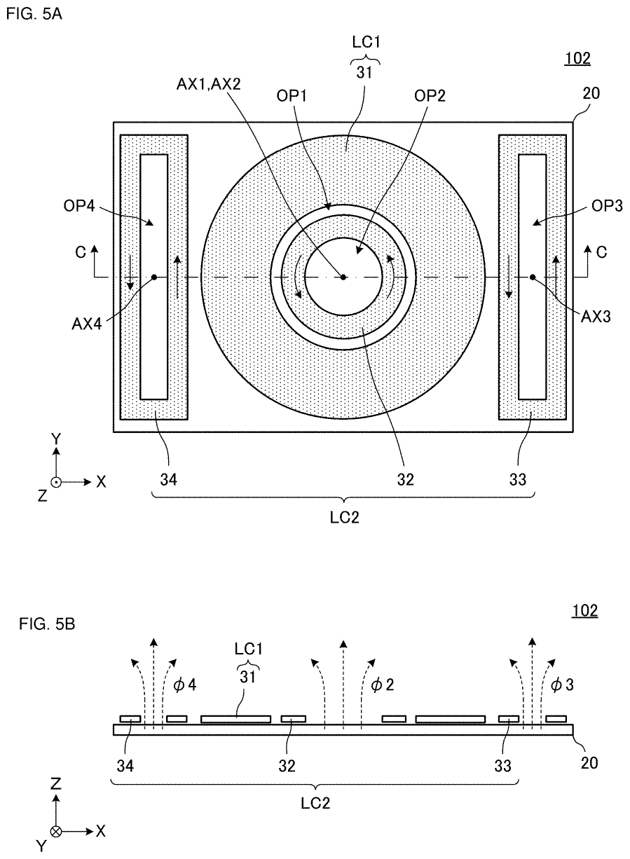

FIG. 5A is a plan view of an antenna device 102 according to the second preferred embodiment, and FIG. 5B is a sectional view of the antenna device 102 taken along line C-C in FIG. 5A. Each of FIGS. 5A and 5B shows only the outer shape of the first coil antenna LC1 (the first coil conductor 31) and the outer shape of the second coil antenna LC2 (the second coil conductor 32, the third coil conductor 33, and a fourth coil conductor 34).

The antenna device 102 differs from the antenna device 101 according to the first preferred embodiment in that the second coil antenna LC2 further includes the fourth coil conductor 34. The antenna device 102 includes a substrate (not shown) whose planar shape is identical or substantially identical to the planar shape of the magnetic material sheet 20 (see the substrate 10 shown in FIGS. 2A, 2B, and 3). The antenna device 102 is otherwise identical or substantially identical to the antenna device 101.

The following describes features of the second preferred embodiment that are different from the features of the antenna device 101 according to the first preferred embodiment.

The fourth coil conductor 34 is a rectangular or substantially rectangular, spiral conductor pattern provided on the substrate (not shown). The fourth coil conductor 34 overlaps neither the first coil conductor 31 nor the first coil opening OP1 when viewed in the Z-axis direction. The fourth coil conductor 34 is provided adjacent to or in a vicinity of a first side of the substrate (the left side of the magnetic material sheet 20 shown in FIG. 5A).

The fourth coil conductor 34, the winding shape of which is not shown, is wound about an axis AX4 to define a fourth coil opening OP4 (see the third coil conductor 33 shown in FIG. 2A). In preferred embodiments of the present invention, the expression “a fourth coil conductor defines a fourth coil opening” means that a fourth coil conductor is wound about an axis to define a fourth coil opening surrounded by the fourth coil conductor.

The second coil conductor 32, the third coil conductor 33, and the fourth coil conductor 34 are electrically connected in series, and a magnetic flux generated by the second coil conductor 32, a magnetic flux generated by the third coil conductor 33, and a magnetic flux generated by the fourth coil conductor 34 are in phase or substantially in phase. As shown in, for example, FIG. 5A, the magnetic material sheet 20 overlaps the first coil conductor 31, the first coil opening OP1, the second coil conductor 32, the second coil opening OP2, the third coil conductor 33, the third coil opening OP3, the fourth coil conductor 34, and the fourth coil opening OP4 when viewed in the Z-axis direction. In other words, when a left-handed current flows through the second coil conductor 32 when viewing the second coil conductor 32, the third coil conductor 33, and the fourth coil conductor 34 in the direction of the axis AX2 of the second coil conductor 32, a left-handed current flows through the third coil conductor 33 and a left-handed current flows through the fourth coil conductor 34. When the winding direction of the second coil conductor 32, the winding direction of the third coil conductor 33, and the winding direction of the fourth coil conductor 34 coincide with each other, the mutual inductance M23 associated with coupling between the second coil conductor 32 and the third coil conductor 33, a mutual inductance M34 associated with coupling between the third coil conductor 33 and the fourth coil conductor 34, and a mutual inductance M24 associated with coupling between the second coil conductor 32 and the fourth coil conductor 34 each have a negative value.

The antenna device 102 according to the second preferred embodiment provides the following advantageous effects in addition to the advantageous effects described in the first preferred embodiment.

The second coil antenna LC2 according to the second preferred embodiment further includes the fourth coil conductor 34 located outside the first coil antenna LC1 when viewed in the Z-axis direction. The second coil conductor 32, the third coil conductor 33, and the fourth coil conductor 34 are electrically connected in series, and a magnetic flux generated by the second coil conductor 32, a magnetic flux generated by the third coil conductor 33, and a magnetic flux generated by the fourth coil conductor 34 are in phase or substantially in phase. These features are able to extend the range over which magnetic fluxes associated with the second coil antenna LC2 are radiated (interlinked). Thus, the range over which the second coil antenna LC2 can couple with coil antennas of transmission targets is able to be further extended.

### Third Preferred Embodiment

A third preferred embodiment of the present invention will be described below by describing an example in which the shapes of the third and fourth coil conductors are different from the shapes of the third and fourth coil conductors of the antenna device 102 according to the second preferred embodiment.

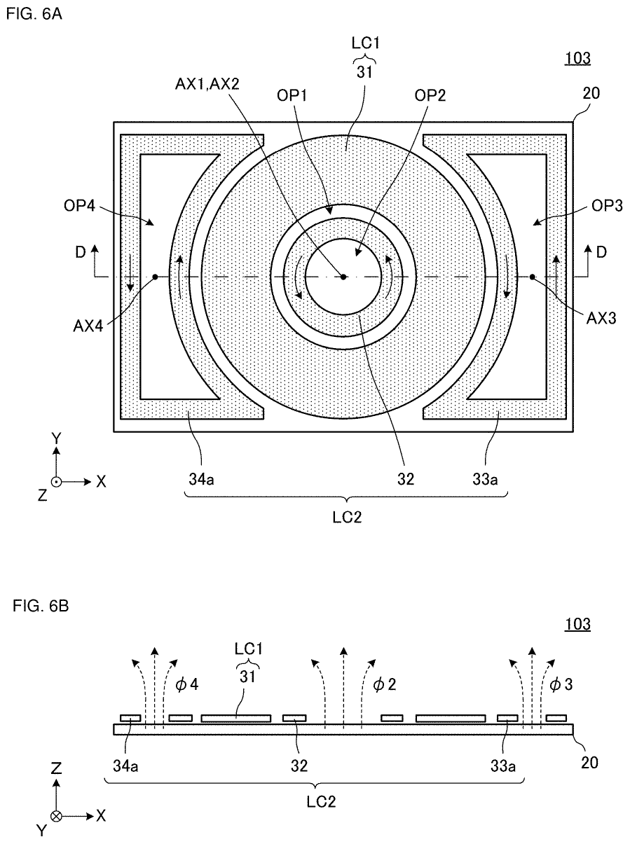

FIG. 6A is a plan view of an antenna device 103 according to the third preferred embodiment, and FIG. 6B is a sectional view of the antenna device 103 taken along line D-D in FIG. 6A. Each of FIGS. 6A and 6B shows only the outer shape of the first coil antenna LC1 (the first coil conductor 31) and the outer shape of the second coil antenna LC2 (the second coil conductor 32, a third coil conductor 33a, and a fourth coil conductor 34a).

The outer shape of the second coil antenna LC2 (the third coil conductor 33a and the fourth coil conductor 34a) of the antenna device 103 is different from the outer shape of the second coil antenna LC2 of the antenna device 102 according to the second preferred embodiment. The antenna device 103 is otherwise identical or substantially identical to the antenna device 102.

The following describes features of the third preferred embodiment that are different from the features of the antenna device 102 according to the second preferred embodiment.

As shown in FIG. 6A, the third coil conductor 33a has an outer shape corresponding to the outer shape of a substrate (see the substrate 10 shown in FIGS. 2A and 2B) and to the outer shape of the first coil conductor 31 when viewed in the Z-axis direction. Specifically, when viewed in the Z-axis direction, the third coil conductor 33a has an outer shape defined by a segment extending along the outer shape of the substrate (the upper side, the right side, and the lower side of the third coil conductor 33a shown in FIG. 6A) and by a segment extending along the first coil conductor (the left side of the third coil conductor 33a shown in FIG. 6A).

The fourth coil conductor 34a has an outer shape corresponding to the outer shape of a substrate and to the outer shape of the first coil conductor 31 when viewed in the Z-axis direction. Specifically, when viewed in the Z-axis direction, the fourth coil conductor 34a has an outer shape defined by a segment extending along the outer shape of the substrate (the upper side, the left side, and the lower side of the fourth coil conductor 34a shown in FIG. 6A) and by a segment extending along the first coil conductor 31 (the right side of the fourth coil conductor 34a shown in FIG. 6A).

The antenna device 103 according to the third preferred embodiment produces the following advantageous effects in addition to the advantageous effects described in the second preferred embodiment.

When viewed in the Z-axis direction, the second coil antenna LC2 (the third coil conductor 33a and the fourth coil conductor 34a) according to the third preferred embodiment has an outer shape defined by the segment extending along the outer shape of the substrate and by the segment extending along the outer shape of the first coil conductor 31 (the first coil antenna LC1). The antenna device with the features described above has a smaller footprint (on the X-Y plane for the formation of the first coil antenna LC1 and the second coil antenna LC2) than the antenna device 102 according to the second preferred embodiment. Furthermore, the coil openings (the third coil opening OP3 and the fourth coil opening OP4) of the second coil antenna LC2 of the antenna device provided as described above may be extended, with no increase in the footprint of the antenna device. These features are able to extend the range and distance over which magnetic fluxes associated with the second coil antenna LC2 are radiated (interlinked). Thus, the range and distance over which the second coil antenna LC2 can couple with coil antennas of transmission targets may be extended.

### Fourth Preferred Embodiment

The following describes a fourth preferred embodiment of the present invention by describing an example antenna device including different types of magnetic material sheets.

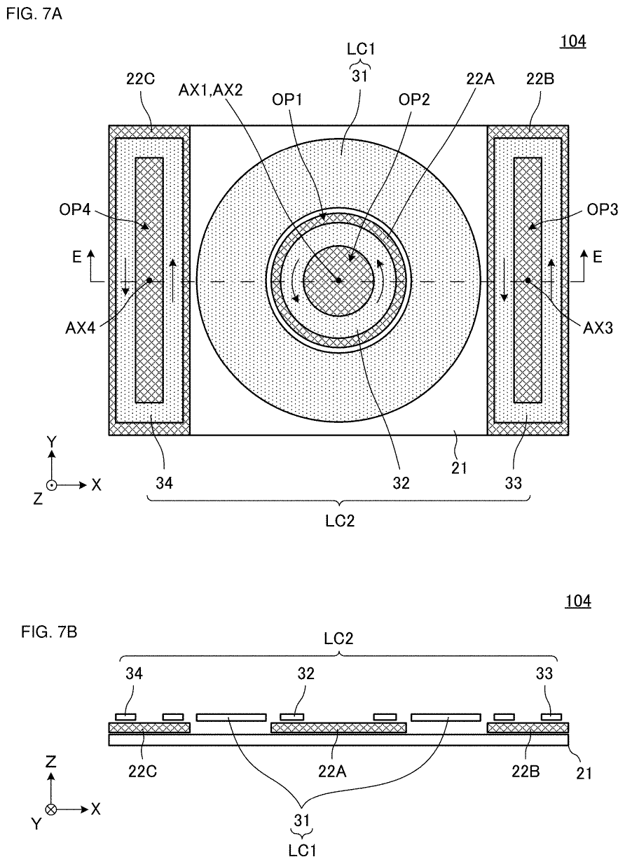

FIG. 7A is a plan view of an antenna device 104 according to the fourth preferred embodiment, and FIG. 7B is a sectional view of the antenna device 104 taken along line E-E in FIG. 7A. Each of FIGS. 7A and 7B shows only the outer shape of the first coil antenna LC1 (the first coil conductor 31) and the outer shape of the second coil antenna LC2 (the second coil conductor 32, the third coil conductor 33, and the fourth coil conductor 34).

The antenna device 104 differs from the antenna device 102 according to the second preferred embodiment in that the antenna device 104 includes a first magnetic material sheet 21 and second magnetic material sheets 22A, 22B, and 22C. The antenna device 104 is otherwise identical or substantially identical to the antenna device 102.

The following describes features of the fourth preferred embodiment that are different from the features of the antenna device 102 according to the second preferred embodiment.

The first magnetic material sheet 21 is a flat plate having a rectangular or substantially rectangular shape whose longitudinal direction coincides with the X-axis direction. The planar shape of the first magnetic material sheet 21 is identical or substantially identical to the planar shape of the substrate (not shown) (see the substrate 10 shown in FIGS. 2A, 2B, and 3). As shown in FIGS. 7A and 7B, the first magnetic material sheet 21 overlaps, for example, the first coil conductor 31 and the first coil opening OP1 when viewed in the Z-axis direction.

The second magnetic material sheet 22A is a circular or substantially circular, flat plate provided substantially in the middle of the substrate (or of the first magnetic material sheet 21). When viewed in the Z-axis direction, the second magnetic material sheet 22A overlaps the second coil conductor 32 and the second coil opening OP2. As shown in FIG. 7B, the second magnetic material sheet 22A is provided between the second coil conductor 32 and the first magnetic material sheet 21. The second magnetic material sheets 22B and 22C are flat plates each having a rectangular or substantially rectangular shape whose longitudinal direction coincides with the Y-axis direction. When viewed in the Z-axis direction, the second magnetic material sheet 22B overlaps the third coil conductor 33 and the third coil opening OP3. As shown in FIG. 7B, the second magnetic material sheet 22B is provided between the third coil conductor 33 and the first magnetic material sheet 21. When viewed in the Z-axis direction, the second magnetic material sheet 22C overlaps the fourth coil conductor 34 and the fourth coil opening OP4. As shown in FIG. 7B, the second magnetic material sheet 22C is provided between the fourth coil conductor 34 and the first magnetic material sheet 21.

Each of the second magnetic material sheets 22A, 22B, and 22C is a member in which the magnetic loss at a second frequency band (13.56-MHz band) used by the second system (the near field communication system) is lower than the magnetic loss in the first magnetic material sheet 21 at the second frequency band. The first magnetic material sheet 21 is preferably a sheet including, for example, MnZn ferrite, and the second magnetic material sheets 22A, 22B, and 22C are preferably sheets including, for example, NiZn ferrite.

The magnetic loss may be calculated using the following loss factor (tan δ).

$$tan δ = \frac{{μ}^{″}}{{μ}^{′}} \qquad [ Math 1 ]$$

μ″: imaginary part of complex permeability

μ′: real part of complex permeability

The saturation flux density (B1) of the first magnetic material sheet 21 is greater than the saturation flux density (B2) of each of the second magnetic material sheets 22A, 22B, and 22C (B1>B2).

The antenna device 104 according to the fourth preferred embodiment produces the following advantageous effects in addition to the advantageous effects described in the second preferred embodiment.

In the fourth preferred embodiment, the first magnetic material sheet 21 overlaps the first coil conductor 31 when viewed in the Z-axis direction, with the magnetic loss in the first magnetic material sheet 21 at a first frequency band used by the first system being lower than the magnetic loss in each of the second magnetic material sheets 22A, 22B, and 22C at the first frequency band. The second magnetic material sheets 22A, 22B, and 22C overlap the coil conductors (the second coil conductor 32, the third coil conductor 33, and the fourth coil conductor 34) of the second coil antenna when viewed in the Z-axis direction, with the magnetic loss in each of the second magnetic material sheets 22A, 22B, and 22C at the second frequency band being lower than the magnetic loss in the first magnetic material sheet 21 at the second frequency band. The antenna device provided as described above is less lossy than the antenna device in which all coil conductors (the first coil conductor, the second coil conductor, the third coil conductor, and the fourth coil conductor) overlap one magnetic material sheet when these coil conductors are viewed in the Z-axis direction (see the antenna device 102 according to the second preferred embodiment).

In the fourth preferred embodiment, the second magnetic material sheets 22A, 22B, and 22C overlap the first magnetic material sheet 21 (each of the second magnetic material sheets 22A, 22B, and 22C is provided between a corresponding coil conductor and the first magnetic material sheet) when viewed in the Z-axis direction. However, the layout of these components is not limited to this example. In some preferred embodiments of the present invention, the second magnetic material sheet does not necessarily overlap the first magnetic material sheet when viewed in the Z-axis direction. It is only required that the second magnetic material sheet overlaps the coil conductors (the second coil conductor, the third coil conductor, and the fourth coil conductor) of the second coil antenna LC2. That is, the first magnetic material sheet 21 may overlap only the first coil conductor 31 and the first coil opening OP1.

Although the fourth preferred embodiment describes that the antenna device includes the second magnetic material sheets 22A, 22B, and 22C corresponding to the individual coil conductors (the second coil conductor 32, the third coil conductor 33, and the fourth coil conductor 34) of the second coil antenna LC2, the features of the antenna device are not limited to this example. One second magnetic material sheet may be provided for the coil conductors of the second coil antenna LC2.

Although the fourth preferred embodiment describes that the second coil antenna LC2 includes three coil conductors (the second coil conductor 32, the third coil conductor 33, and the fourth coil conductor 34), the second coil antenna LC2 is not limited thereto. As in the antenna device 102 described in the second preferred embodiment, the second coil antenna LC2 may include two coil conductors (the second coil conductor 32 and the third coil conductor 33). That is, the fourth coil conductor 34 and the second magnetic material sheet 22C may be optionally included.

### Fifth Preferred Embodiment

The following describes a fifth preferred embodiment of the present invention by describing an example electronic apparatus including an antenna device according to a preferred embodiment of the present invention.

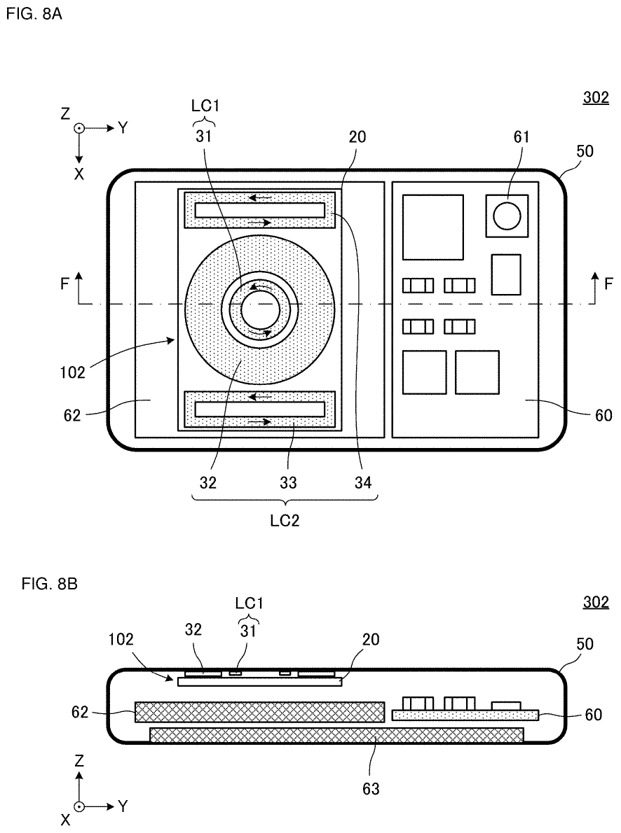

FIG. 8A is a plan view of an electronic apparatus 302 according to the fifth preferred embodiment, and FIG. 8B is a sectional view of the electronic apparatus 302 taken along line F-F in FIG. 8A.

The electronic apparatus 302 includes a housing 50, the antenna device 102, a circuit board 60, a device 61, a battery pack 62, and a display 63. The antenna device 102 is as described in the second preferred embodiment.

The outer shape of the housing 50 is a rectangular parallelepiped or a substantially rectangular parallelepiped whose longitudinal direction coincides with the X-axis direction. Components such as the antenna device 102, the circuit board 60, the device 61, the battery pack 62, and the display 63 are accommodated in the housing 50. The antenna device 102 is attached to an inner surface of the housing 50 (an upper, inner surface of the housing 50 shown in FIG. 8(B)). Components such as the device 61 are mounted on the circuit board 60. The device 61 is, for example, a camera module, a flash, a speaker, an earphone jack, a card slot, a terminal such as an USB terminal, a button, or a sensor.

The first system circuit and the second system circuit in the first preferred embodiment, which are not shown, are also mounted on the circuit board. The first system circuit is electrically connected to both ends of the first coil antenna LC1, and the second system circuit is electrically connected to both ends of the second coil antenna LC2.

The battery pack 62 includes a conductor portion (e.g., a metal portion such as an outer jacket), which is not shown. In the fifth preferred embodiment, the conductor portion (the metal portion) included in the battery pack 62 corresponds to a metal member of a preferred embodiment of the present invention.

As shown in FIGS. 8A and 8B, the magnetic material sheet 20 of the antenna device 102 is provided between the battery pack 62 and each of the first coil antenna LC1 (the first coil conductor 31) and the second coil antenna LC2 (the second coil conductor 32, the third coil conductor 33, and the fourth coil conductor 34).

As shown in FIG. 8A, the third coil conductor 33 and the fourth coil conductor 34 viewed in the axial direction (Z-axis direction) of the first coil conductor 31 are closer than the first coil conductor 31 to the outer edge of the housing 50 viewed in the Z-axis direction. In the fifth preferred embodiment, the third coil conductor 33 and the fourth coil conductor 34 are located adjacent to or in a vicinity of corresponding long sides defining a portion of the outer edge of the housing 50 (the upper side and the lower side of the housing 50 in FIG. 8A) when viewed in the Z-axis direction.

In the fifth preferred embodiment, the magnetic material sheet 20 is provided between the battery pack 62 (the metal member) and each of the first coil antenna LC1 and the second coil antenna LC2. Accordingly, an influence of the metal member is reduced, and the magnetic shielding effect of the magnetic material sheet significantly reduces or prevents unwanted coupling between each of these coil antennas and the metal member located in the −Z direction with respect to the antenna device 102.

In the fifth preferred embodiment, the third coil conductor 33 and the fourth coil conductor 34 are located adjacent to or in a vicinity of the outer edge of the housing 50. Accordingly, the possibility that coupling between the second coil antenna LC2 and a coil antenna of a transmission target will be interfered with by, for example, other components accommodated in the housing 50 is able to be significantly reduced or prevented.

Although the fifth preferred embodiment describes that the conductor portion (the metal portion) included in the battery pack 62 corresponds to the metal member of a preferred embodiment of the present invention, the metal member is not limited thereto. The metal member of a preferred embodiment of the present invention is a metal portion such as, for example, a conductor pattern (e.g., a ground conductor) provided on a circuit board, another on-board component, or a shielding plate provided on a back surface of the display.

In the fifth preferred embodiment, the third coil conductor 33 and the fourth coil conductor 34 are located adjacent to or in a vicinity of the corresponding long sides defining a portion of the outer edge of the housing 50 when viewed in the Z-axis direction. However, the layout of these components is not limited to this example. When viewed in the Z-axis direction, the third coil conductor 33 and the fourth coil conductor 34 may be located adjacent to or in a vicinity of corresponding short sides defining a portion of the outer edge of the housing 50. The fourth coil conductor 34 may be optionally included.

### Other Preferred Embodiments

Although the substrate 10 according to the above-described preferred embodiments is a flat plate having a rectangular or substantially rectangular shape, the substrate 10 is not limited thereto. The planar shape of the substrate 10 may be changed as appropriate within the bounds of including features and advantages of the preferred embodiments of the present invention and may be, for example, a polygon, a circle, an ellipse, an L-shape, a T-shape, or a crank-shape.

Although the substrate 10 according to the above-described preferred embodiments is a thermoplastic sheet, the substrate 10 is not limited thereto. For example, the substrate 10 may be a thermosetting resin sheet or a dielectric ceramic substrate including low-temperature co-fired ceramics (LTCC). Alternatively, the substrate 10 may be a multilayer body including a plurality of insulating substrate layers stacked on one another. Still alternatively, the substrate 10 may be a composite multilayer body including a plurality of resin layers and may include, for example, a thermosetting resin layer such as a glass-epoxy substrate and a thermoplastic resin layer that are stacked.

Although the above-described preferred embodiments describe that the first coil antenna LC1 includes two first coil conductors electrically connected in parallel, the first coil antenna LC1 is not limited thereto. The first coil antenna LC1 may include one coil conductor or may include three or more coil conductors electrically connected in parallel. Although the above-described preferred embodiments describe that the second coil antenna LC2 includes two coil conductors electrically connected in series (the second coil conductor 32 and the third coil conductor 33) or three coil conductors electrically connected in series (the second coil conductor 32, the third coil conductor 33, and the fourth coil conductor 34), the second coil antenna LC2 is not limited thereto. The second coil antenna LC2 may include four or more coil conductors electrically connected in series.

Although the above-described preferred embodiments describe that each of the coil conductors included in the first coil antenna LC1 and the coil conductors included in the second coil antenna LC2 has a circular, substantially circular, rectangular, or substantially rectangular outer shape, the outer shape of each coil conductor is not limited thereto. The outer shape of each coil conductor may be changed as appropriate within the bounds of including features and advantages of the preferred embodiments of the present invention. Similarly, the number of turns of each coil conductor and the distance between the individual coil conductors may be changed as appropriate within the bounds of including features and advantages of the preferred embodiments of the present invention.

Although the above-described preferred embodiments describe that the axis AX1 of the first coil conductors 31a and 31b coincides with the axis AX2 of the second coil conductor 32, the layout is not limited this example. It is only required that the axis AX1 and the axis AX2 are in parallel or substantially in parallel.

Although the above-described preferred embodiments describe that the antenna device includes a magnetic material sheet that is a flat plate having a rectangular, substantially rectangular, circular, or substantially circular shape, the magnetic material sheet is not limited thereto. The planar shape of the magnetic material sheet may be changed as appropriate within the bounds of including features and advantages of the preferred embodiments of the present invention. The antenna device according to the preferred embodiments of the present invention may optionally include the magnetic material sheet.

Although the above-described preferred embodiments describe that the first system is a wireless power supply system such as, for example, a magnetic-field resonance power transmission system and that the second system is a near field communication system such as, for example NFC, the first and second systems are not limited thereto. The first and second systems may be two different systems other than communication systems and power transmission systems.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a first coil antenna provided for a first system, the first coil antenna including a first coil conductor defining a first coil opening; and
a second coil antenna provided for a second system, the second coil antenna including a second coil conductor defining a second coil opening and a third coil conductor defining a third coil opening; wherein
the second coil conductor is disposed in the first coil opening when viewed in an axial direction of the first coil conductor;
the third coil conductor and the third coil opening overlaps neither the first coil conductor nor the first coil opening when viewed in the axial direction of the first coil conductor;
the second coil conductor and the third coil conductor are electrically connected in series; and
a magnetic flux generated by the second coil conductor and a magnetic flux generated by the third coil conductor are in phase or substantially in phase.

2. The antenna device according to claim 1, wherein
the second coil antenna further includes a fourth coil conductor defining a fourth coil opening;
the fourth coil conductor overlaps neither the first coil conductor nor the first coil opening when viewed in the axial direction of the first coil conductor,
the second coil conductor, the third coil conductor, and the fourth coil conductor are electrically connected in series; and
a magnetic flux generated by the second coil conductor, a magnetic flux generated by the third coil conductor, and a magnetic flux generated by the fourth coil conductor are in phase or substantially in phase.

3. The antenna device according to claim 1, further comprising a magnetic material member that overlaps the first coil conductor, the first coil opening, the second coil conductor, the second coil opening, the third coil conductor, and the third coil opening when viewed in the axial direction of the first coil conductor.

4. The antenna device according to claim 2, further comprising a magnetic material member that overlaps the first coil conductor, the first coil opening, the second coil conductor, the second coil opening, the third coil conductor, the third coil opening, the fourth coil conductor, and the fourth coil opening when viewed in the axial direction of the first coil conductor.

5. The antenna device according to claim 1, further comprising:
a first magnetic material member that overlaps the first coil conductor and the first coil opening when viewed in the axial direction of the first coil conductor; and
a second magnetic material member that overlaps the second coil conductor, the second coil opening, the third coil conductor, and the third coil opening when viewed in the axial direction of the first coil conductor; wherein
a magnetic loss in the second magnetic material member at a second frequency band used by the second system is lower than a magnetic loss in the first magnetic material member at the second frequency band.

6. The antenna device according to claim 2, further comprising:
a first magnetic material member that overlaps the first coil conductor and the first coil opening when viewed in the axial direction of the first coil conductor; and
a second magnetic material member that overlaps the second coil conductor, the second coil opening, the third coil conductor, the third coil opening, the fourth coil conductor, and the fourth coil opening when viewed in the axial direction of the first coil conductor; wherein
a magnetic loss in the second magnetic material member at a second frequency band used by the second system is lower than a magnetic loss in the first magnetic material member at the second frequency band.

7. An electronic apparatus comprising:
a housing; and
an antenna device accommodated in the housing; wherein
the antenna device includes:
a first coil antenna provided for a first system, the first coil antenna including a first coil conductor defining a first coil opening; and
a second coil antenna provided for a second system, the second coil antenna including a second coil conductor defining a second coil opening and a third coil conductor defining a third coil opening;
the second coil conductor is disposed in the first coil opening when viewed in an axial direction of the first coil conductor;
the third coil conductor and the third coil opening overlaps neither the first coil conductor nor the first coil opening when viewed in the axial direction of the first coil conductor;
the second coil conductor and the third coil conductor are electrically connected in series; and
a magnetic flux generated by the second coil conductor and a magnetic flux generated by the third coil conductor are in phase or substantially in phase.

8. The electronic apparatus according to claim 7, wherein
the second coil antenna further includes a fourth coil conductor defining a fourth coil opening;
the fourth coil conductor overlaps neither the first coil conductor nor the first coil opening when viewed in the axial direction of the first coil conductor;
the second coil conductor, the third coil conductor, and the fourth coil conductor are electrically connected in series; and
a magnetic flux generated by the second coil conductor, a magnetic flux generated by the third coil conductor, and a magnetic flux generated by the fourth coil conductor are in phase or substantially in phase.

9. The electronic apparatus according to claim 7, wherein, when viewed in the axial direction of the first coil conductor, the third coil conductor is closer than the first coil conductor to an outer edge of the housing.

10. The electronic apparatus according to claim 8, wherein the third coil conductor and the fourth coil conductor are closer than the first coil conductor to an outer edge of the housing.

11. The electronic apparatus according to claim 7, further comprising:
a metal member; and
a magnetic material member; wherein
the magnetic material member is in between the metal member and each of the first coil antenna and the second coil antenna.

12. The antenna device according to claim 1, wherein the first coil conductor includes a spiral conductor pattern provided on a first surface of a substrate and at least one looped conductor pattern provided on a second surface of the substrate opposite to the first surface of the substrate.

13. The antenna device according to claim 12, wherein the spiral conductor pattern and the at least one looped conductor pattern are electrically connected in parallel.

14. The antenna device according to claim 1, wherein the second coil conductor is provided on a same surface of a substrate as the third coil conductor.

15. The antenna device according to claim 1, further comprising:
a first outer electrode; and
a second outer electrode; wherein
a first end of the second coil conductor is electrically connected to the first outer electrode;
a second end of the second coil conductor is electrically connected to a first end of the third coil conductor; and
a second end of the third coil conductor is electrically connected to the second outer electrode.

16. The antenna device according to claim 1, wherein the magnetic flux generated by the second coil conductor and the magnetic flux generated by the third coil conductor are in a same or substantially a same orientation in the Z-axis direction.

17. The electronic apparatus according to claim 7, further comprising:
a first capacitor electrically connected in series with the first coil conductor;
a second capacitor electrically connected in parallel with the first coil conductor;
a third capacitor electrically connected in parallel with the second coil conductor and the third coil conductor.

18. The electronic apparatus according to claim 7, further comprising:
a matching circuit electrically connected between the antenna device and the second system; wherein
the matching circuit includes at least one electro-magnetic compatibility (EMC) filter.
